(19) United States
(12) Patent Application Publication
(10) Pub. No.: US 2006/0074621 A1
(43) Pub. Date: Apr. 6, 2006

(54) Apparatus and method for prioritized grouping of data representing events

(76) Inventor: Ophir Rachman, Sunnyvale, CA (US)

Correspondence Address: MARSH, FISCHMANN & BREYFOGLE LLP, 3151 SOUTH VAUGHN WAY, SUITE 411, AURORA, CO, 80014, US

(21) Appl. No.: 10/931,297

(22) Filed: Aug. 31, 2004

(51) Int. Cl. G06F 9/45

(52) U.S. Cl. 703/22

(57) ABSTRACT

An apparatus and method for the grouping and prioritization of data events using behavioral modeling. The number of events to be analyzed is reduced by generating a behavioral model comprising modeling events groups, by grouping similar events into event groups, by calculating and assigning priority indicators based on the characteristics of the event groups and the behavioral model.

### BACKGROUND OF THE INVENTION

1. Field of the Invention

The present invention relates generally to data processing systems and more particularly to a data analysis system where the amount of analyzed data elements is reduced through automatic grouping and prioritization of data elements.

2. Discussion of the Related Art

In today's world, vast amounts of potentially meaningful data are generated, captured, monitored, collected and stored either in raw format, such as, for example, unstructured texts from the World Wide Web, or as structured post-processed data typically kept in ordered databases. The masses of data are obtained from a multitude of data capturing and data processing systems operating practically across the entire field of human endeavor. In order to extract meaningful and relevant information from these massive aggregates of data, suitable managerial and analytic techniques should be applied. Many organizations that are interested in deriving useful information from data collections must invest heavily in extraction and analysis procedures in order to reach the desired useful information.

The high costs involved in the extraction and processing of the data are offset by the enormous potential promised by deriving meaningful and useful results from the collected data. Therefore, a great deal of effort is invested within the data processing community and the data users community for developing, finding and utilizing suitably generic and automatic techniques effective in the efficient analysis of the aggregated masses of data. The set of generic techniques and algorithms that can handle mass amounts of data is typically referred to as data mining. Data mining are processes through which coherent patterns may be derived from huge amounts of unstructured information stored in data storages, such as, for example, data warehouses, acquired by such means as survey management systems, consumer management systems, purchasing systems, financial and banking systems, billing systems, scientific research results, network monitoring systems, security and surveillance systems, and the like. Data mining could be used to a plurality of useful tasks by the utilization of computing power in order for example to profile the individual's tastes and habits and perform “predictive analysis” in order to predict future behavior from the seemingly random data stream that is combined of actions and attitudes.

Consequent to the improvements in both hardware and software and the rise of the World Wide Web, data mining is typically done by automatically collecting all available data, such as large amounts of possibly unordered records, often with a high dimensionality and then searching for meaningful patterns, such as correlations between certain parameters, periodic cycles, and the like. A major problem with currently existing data mining techniques is the need for the all-inclusive and comprehensive extraction and processing of a huge number of randomly located information units spanning extensive ranges of typical data aggregates. One solution could be a selective or segmented extraction and processing of the data aggregates. The disadvantage of this solution lies in the fact that in a randomly organized data aggregate it is problematic to have a prior knowledge concerning the relative importance of the different segments of a typical data collection. Thus, unordered and unstructured selective data reading and data processing could result in overlooking potentially application-critical segments of information distributed in an unpredictable manner across the data aggregate.

There is an urgent need for a data mining apparatus and method that will substantially reduce the number of analyzable data elements constituting an aggregated mass of data without the risk of missing application-critical and analysis-result-critical data elements. Preferably, the reduction of the number of analyzable data elements will be performed in a controllable manner via the generation of event groups connected by pre-defined group-identification definitions, via the suitable ordering of the event groups, and via the selective application of appropriate analysis processes across the event groups.

### SUMMARY OF THE PRESENT INVENTION

One aspect of the present invention regards an apparatus for the grouping and prioritization of events. The apparatus comprises a behavioral model builder and model storage component to generate and update modeling event groups in a behavioral model in accordance with the value of parameters characterizing a modeling event, a behavioral model storage to store a behavioral model into a behavioral model storage, and an event analyzer component to associate an event with an event group, and to calculate the priority indicator of the event group in accordance with the characteristics of the associated event, with the quality of matching achieved between the event information stored in the modeling events group in the behavioral model and the characteristics of the event.

A second aspect of the present invention regards a method for the grouping and prioritization of events. The apparatus comprises generating a behavioral model comprising one or more behavioral modeling event groups based on one or more characteristics of one or more modeling events, grouping one or more events into an events group based on the characteristics of the events and based on the characteristics of one or more substantially matching modeling event groups in the behavioral model, calculating a priority value characterizing the event group, and assigning the priority value to the event group.

### BRIEF DESCRIPTION OF THE DRAWINGS

The present invention will be understood and appreciated more fully from the following detailed description taken in conjunction with the drawings in which:

FIG. 1 is a schematic block diagram illustrating the components of the proposed apparatus and method, in accordance with a preferred embodiment of the present invention;

FIG. 2 is a schematic block diagram illustrating the structure and functionality of the behavioral model, in accordance with a preferred embodiment of the present invention; and

FIG. 3 is a flowchart illustrating the operation of behavioral model creation, in accordance with a preferred embodiment of the present invention;

FIG. 4 is a flowchart illustrating the operation of the of the event analysis, in accordance with a preferred embodiment of the present invention.

### DETAILED DESCRIPTION OF THE PREFERRED EMBODIMENT

An apparatus and method for the automatic grouping and prioritization of data events using behavioral modeling is disclosed. The proposed apparatus and method is implemented in a system requiring analyzing events and determining the handling of events. Such can include, for example, denying or allowing credit transactions, investigate events that may represent security threats, and the like. The objective of the suggested apparatus and method is to provide for an optimized enhanced analysis of events. The objectives of the proposed apparatus and method are achieved by a) reducing the number of events to be analyzed by grouping similar events together into event groups, and b) automatically providing priorities to events groups, such that more important groups will be analyzed first while less important groups may be postponed or ignored.

The proposed apparatus and method obtains data records representative of events, from a data aggregate via event collector means. In the context of this document, an event is an encoded data record that represents occurrences of some type on a regular basis. Events are detected and identified by an event detector device, such as, for example, a specifically tasked computer program. Events that are recognized by the event detector means as “significant” or “interesting” or “meaningful” or “out-of-the-ordinary” typically evoke a pre-determined response. Such response could involve the activation of an event processing device, such as a specifically tasked computer program. Event detection, event identification and event processing logic is typically pre-defined by human users, for example, pre-defining event parameters values as “triggers” for specific handling of the events, and the like. For example, the user will define a list of events to be handled by the system, how an event is identified and for each event which parameters are to be extracted. An event consists of one or more parameters where a parameter includes a pair of data elements, such as a parameter type and a parameter value. The parameter type is one of a finite set of pre-defined parameter types and the parameter value is data of any length and type typically represented as a string, such as names, phone numbers, dates, and the like. Each event includes a unique identifier and a timestamp that identifies the point of time at which the event occurred. Collected events are stored either in real-time or off-line into an events storage, such as a database. The database could be a local database, a remote database or a distributed database. In one example, events storage could hold credit card transactions for a credit card service provider. The set of associated parameters types could include time of transaction, date of transaction, amount of payment, point of sale identification, list of purchased items, and the like. The values may be any of the values appropriate for the parameter types. In another example, events storage could hold security logs generated by an Intrusion Detection System (IDS) and possibly other security sensors. The set of parameters may include source IP address, destination IP address, port numbers, time, date, file names, user names, and the like. The values may be any of the values appropriate for the parameter types.

The proposed apparatus and method is implemented in two processing stages. In the first processing stage a behavioral model is built that represents the characteristics of the events in a normal flow of events in a given environment. Initially, the behavioral model is built based on a set of events from a given period. Consequently the behavioral model could be updated to reflect changes in the environment based on additional one or more events. The behavioral model represents parameter value classifications, events groups, and patterns. A parameter value classification includes distinct groups or classes of parameter values for a specific parameter type. The process of parameter values classification is based on a specific similarity metric that is defined for potential parameter values for the specific parameter type and on the application of clustering techniques based on the similarity metric. Based on the classifications the behavioral model defines similarity metric between events. Given two events, the similarity metric defines the distance between these events by factoring all the relevant classifications for the parameter types of the two events. Based on the similarity metric clustering techniques are used to generate groups of events. A pattern is a consistent and well defined behavior that is identified in the set of events represented in the behavioral model. A pattern is any logical statement that applies to events and parameter types and parameter values. A more detailed description concerning the structure and the functionality of the behavioral model will be set forth herein under in association with the following drawings.

In the second processing stage real-time or periodical event analysis is performed. The proposed apparatus and method of the present invention provides analysis methods for a) real-time analysis of the events as the events are being stored in the events storage, and b) periodic analysis of events from a specific period that are already stored in the events storage. The periodical analysis obtains and analyses a set of events based on an existing behavioral model. The analysis consists of several steps, such as grouping the analyzed events, matching the groupings of the analyzed events to the modeling event groups in the behavioral model, calculating and scoring modeling pattern violations, and calculating and assigning priority scores to the groupings of the analyzed events. The real-time analysis is substantially similar to the periodical analysis where the differences involve constrains associated with the fundamental nature of real-time processing. A more detailed description concerning the periodical analysis and the real-time will be set forth herein under in association with the following drawings.

In the preferred embodiment of the present invention the events are triggered by security products and are typically called “alerts”. Thus, the proposed apparatus and method could be associated with and work in close cooperation with various computer security products, such as anti-virus programs attempting to locate harmful viruses within the arriving network packets, intrusion detection systems responsible for the identification of intrusion events, firewall designed to stop traffic having particular characteristics, such as port address, data router security systems, Distributed Denial-of-Service (DDos) attack detectors, and the like. In the preferred embodiment of the present invention the event analysis apparatus and method provide real-time processing, periodic processing, or off-line processing options. In other preferred embodiments of the invention, the analysis could be applied to other types of data items or other types of events, such as credit card transactions in order to identify fraudulent transactions, financial and banking data to recognize transactions not in compliance with laws and regulations, surveillance records in order to locate alarm situations, or airport-based or aircraft-based sensor data to locate emergency situations, debugging messages, logging information generated by monitoring systems, and the like.

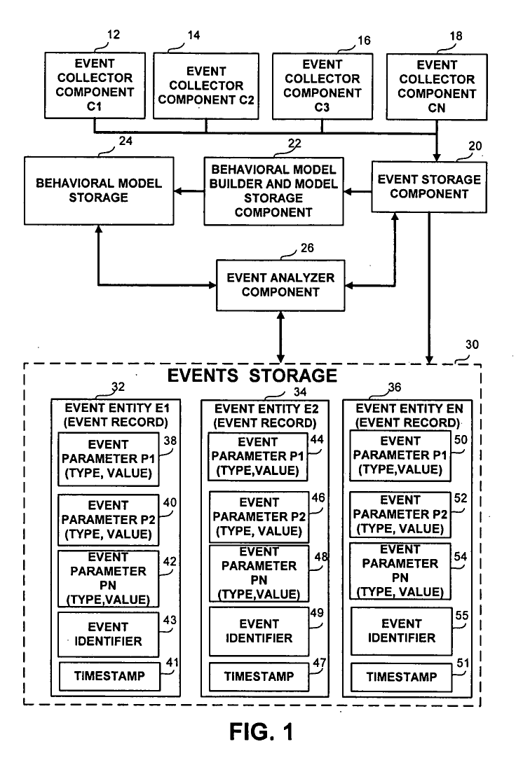

Referring now to FIG. 1 the proposed apparatus and method processes obtained events which represent occurrences of specific types on a regular basis. The events are collected in real-time or off-line from multiple event sources by event collectors component C1 (12), event collectors component C2 (14), event collectors component C3 (16), and event collectors component CN (18). Event collectors components 12, 14, 16, 18 could be computer input devices, communication network interfaces, databases storing aggregates of raw or structured data, sensor devices, and the like. Collected events are inserted into an events storage 30 by the event storage component 20 as event entity E1 (32), event entity E2 (34), and event entity EN (36). Event storage component 20 is typically a software routine the responsibility of which is to store the collected events into the event storage 30 as event records 32, 34, and 36. Event storage 30 is preferably an advanced data structure, such as database installed on Direct Access Device, a hard disk device, a mass storage device, or a RAID device. Consequent to the storage of the events storage 30 will hold event entity records 32, 34, and 36. An event entity record in the event storage 30 consists of several data fields. Thus, event entity E1 (32) includes event parameter P1 (38), event parameter P2 (40), and event parameter PN (42) while event entity E2 (34) includes event parameter P1 (44), event parameter P2 (46), and event parameter PN (48) and event entity EN (36) includes event parameter P1 (50), event parameter P2 (52), and event parameter PN (54). Although on the drawing under discussion only a limited number of event entities and a limited number of event parameters are shown in realistic environment event storage 30 could hold a plurality of event entities where each event entity could store a set of event parameters. Event entities E1 (32), E2 (34), and EN (36) store event parameters 1 (38), 2 (40), N (42), and event parameters 1 (44), 2 (46), N (48), and event parameters 1 (50), 2 (52), and N (54) respectively. Event entities 1 (32), 2 (34) and N (36) further store event identifiers 43, 49, and 55, and timestamps 41, 47, 51, respectively. Each event parameter 38, 40, 42, 44, 46, 48, 50, 52, 54 includes a parameter type field and a parameter value field. A parameter type field stores one out of a finite set of pre-defined parameter types kept preferably in designated control tables. The parameter value is data that could have any length, format and data type. In the preferred embodiment of the invention, a parameter value is typically represented by a string, such as names, phone numbers, dates, and the like. The values of the event identifiers 43, 49, and 55 uniquely identify the event. In the preferred embodiment of the invention the value of the event identifiers is preferably assigned in an incremental manner via specifically designated counter devices. The value of the timestamps 41, 47, and 51 identify the time and date at which the event has occurred. In the preferred embodiment of the present invention, the event storage 30 stores computer security logs generated by an intrusion detection system or any other security sensor systems. The set of parameter types includes source IP address, destination IP address, port numbers, time, date, file names, user names, and the like. The parameter values could be any values appropriate for the parameter types. Note should be taken that the event storage 30 could be implemented as one or more local databases and/or as one or more remote/external/distributed databases, or directly in raw form in a storage device including, but not limited to magnetic or optic media, resident or temporary access memory or the like.

Still referring to FIG. 1 the behavioral model represents a period in the past that defines “normal behavior”. Updating the model can be done in at least two distinct ways: 1) manually re-building the model based on a newly defined period of time or 2) defining an updating policy that may update the model periodically in order to include additional events and preferably eliminate the impact of older events. In the preferred embodiment of the invention a behavioral model builder and model storage component 22 is activated in accordance with the current updating policy or consequent to manual re-build instructions during event storage by the event storage component 20. For each new event that is collected by the event collector components C1 (12), C2 (14), C3 (16), CN (18) are stored in the event storage 30. The behavioral model builder and model storage component 22 performs event processing in order to obtain the characteristics of the event, and to update the model storage 24. The model storage 24 is a data structure, such as a database, for example, that holds a set of modeling event groups. The new event is assigned to a suitable modeling event group. The model storage 24 is utilized consequently during the performance of the real-time or periodical event analysis. The proposed apparatus and method allow for effective analyzing and decision making concerning appropriate handling of newly received events. The decision making could involve potential actions, such as denying or allowing credit transactions, investigate events that may represent security threats, and the like. In order to achieve optimal decisions concerning the occurrence of the events the events has to be analyzed. The event analyzer component 26 is a set of software routines that analyze the events either in real-time or periodically where the analysis is assisted by the behavioral model stored in the behavioral model storage 24. The events are analyzed selectively via the grouping of the events into analysis events groups, assigning priority values indicating importance factors to the analysis events groups, and providing the option of either analyzing a limited number of analysis event groups or analyzing the groups in accordance with the priority values indicating group importance. Behavioral model building by the behavioral model builder and model storage component 22 is performed periodically, for example, each time a new event or a set of events are collected, extracted, or stored over a predetermined region of time or other parameters. Event analysis could be performed in real-time where the analysis is applied on events being stored in the event storage. Event analysis could be performed substantially continuously in a manner separate or parallel to the event storage. Periodic event analysis could be performed by request for pre-defined periods in order to perform specialized processing, such as analyze one or more specific analysis event groups in order to look for specifically pre-defined time-sensitive events already stored in the events storage 30.

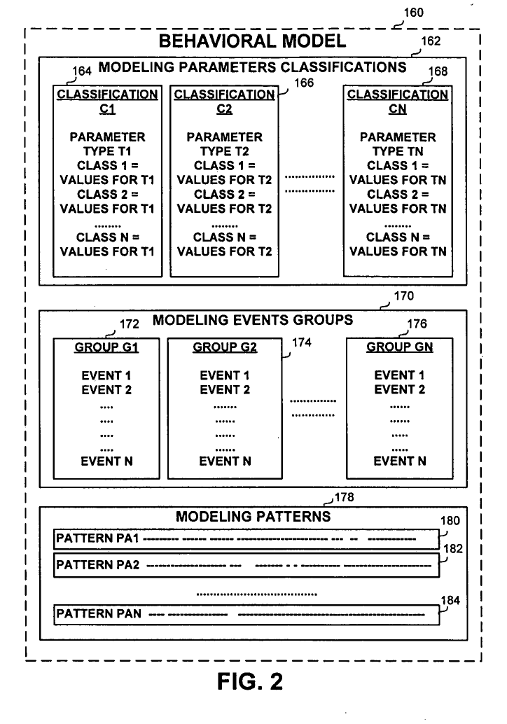

Referring now to FIG. 2 the behavioral model 160 is implemented in a data structure, such as a computer-readable database. Behavioral model 160 represents the attributes of the events in a normal flow of events in a given environment. The behavioral model 160 represents a set of events, which dictates a set of possible values for each parameter type associated with the events. Initially the behavioral model 160 is generated based on a set of events from a given period of time. Subsequently, the model 160 is further updated in order to reflect changes in the environments based on additional events. The model 160 includes modeling parameter classifications 162, modeling events groups 170, and modeling patterns 178. Parameter classifications 162 includes classification C1 (162), classification C2 (166), classification CN (168). Note should be taken that parameters classifications 162 could include a plurality of classifications. Although the classifications 162, 164, 168 each are related to a single parameter type there may be more than one classification defined for a certain parameter type. Each classification defines classes and each class contains a set of values for the parameter type of the classification. Each parameter type appears typically in one class of the classification. Classification C1 (164) relates to parameter T1 and includes several value classes, such as class 1, class 2, class N. Classification C2 (166) relates to parameter T2 and includes several classes, such as class 1, class 2, class N. Classification CN (168) relates to parameter TN and includes several classes, such as class 1, class 2, class N. The classification is based on a specific similarity metric that is pre-defined for all the possible parameter values for the parameter type and by the application of clustering techniques based on the similarity metric. One example of a classification concerns a parameter type “file name” for which a similarity metric could be defined based on the file extension value. Thus, file names may be classified to groups of files having identical file extension indicators, such as “exe”, “dll”, “htm”, and the like. Another example for a classification concern a parameter type “item bought” for which a similarity metric can be defined based on the nature of items. The items may be classified to groups of items of the same nature, such as “beauty products”, “home improvement products”, and the like. Each classification is assigned a quality value. The quality value could be either assigned manually or could be computed automatically, for example, by the performance of a function defined on the parameter values and based on the distance between parameter values in the various classes of the classification. For example, a distance between parameters can be the difference between values, the result of a function performed on the different values assigned to the parameters types, the statistical variance between the values assigned to groups of values and the like. Alternatively, quality value could be defined manually, by assigning basic values to each parameter type.

Still referring to FIG. 2, modeling events groups 170 includes events group G1 (172), events group G2 (174), events group GN (176). Event group G1 (172) includes event 1, event 2, event N. Events group G2 (174) includes event 1, event 2, event N. Events group GN (176) includes event 1, event 2, event N. Each events group 172, 174, 176 contains some events from the model events and each event typically appears in one events group. Based on the classes concerning the model events groups a similarity metric is defined between events. Given two events, the similarity metric defines the “distance measure” between these events via the factoring of all the relevant classifications with the qualities thereof for the parameter types of the two events. For example a distance function between two events can be defined in a ‘binary’ way. Two events can have either distance 100 (not similar) or distance 0 (similar). Two events E1 and E2 are defined to be similar if a) they consist of the same parameters types T1, T2, . . . ,TN, and b) for each parameter type Ti and for each classification Ci of parameter type Ti, the values V1 and V2 of parameter type Ti in E1 and E2 respectively belong to the same class in Ci. For another example one can define a more granular distance function by taking into consideration all the classifications and their qualities. More precisely, consider two events E1 and E2 with parameters type T1,T2, . . . ,TN and respective values for this parameters V11,V12, . . . ,V1N (for event E1) and V21,V22, . . . ,V2N (for event E2). Now consider all the classifications C1,C2, . . . ,CM with their respective qualities Q1,Q2, . . . ,QM. The distance between E1 and E2 is defined by calculating the number Si per classification Ci which is Qi if V1i and V2i are belong to the same class in Ci and zero otherwise. Then, the distance between E1 and E2 is defined as (S1+S2+ . . . +SM)×100 divided by (Q1+Q2+ . . . +QM), This calculation gives a distance between 0-100 that factors all the classifications with their respective qualities. Utilizing the similarity metric clustering techniques are used to create model events groups. Modeling patterns 178 includes pattern PA1 (180), pattern PA2 (182), pattern PAN (184). A pattern is a consistent and properly defined behavior of the events as represented in the behavioral model 160. A pattern includes a pattern identification or pattern code and one or more logical statements that may apply to events, parameter types and parameter values. Examples of logical statements associated with patterns could include: (a) “If an event has a parameter value V1 for parameter type T1, then the event has one of the following parameter values {V2, V3, V4} for parameter type T2″, b) “If an event with timestamp D1 has parameter value V1 for parameter type T1, then there is event with timestamp no later than (D1+3 seconds) that has parameter value T2 for parameter type T2″, and c) There are always between C1 and C2 events with parameter value V1 for parameter type T1 between any two timestamps D1 and D2 such that D2−D1=1 hour.” There could be various types of event patterns and the behavioral model 160 could be configured to allow various types and templates of event patterns and to allow various parameter types and values to participate in any event pattern type. The behavioral model 160 is also analyzing the quality of the patterns 178. The resulting quality value represents how characteristic or non-characteristic the pattern is.

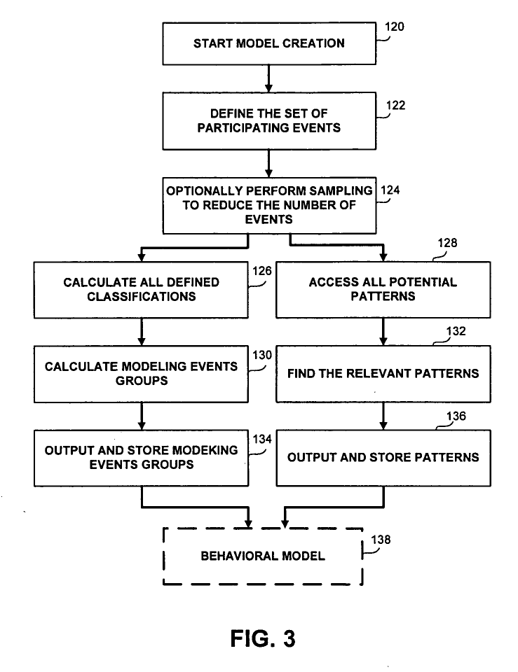

Referring now to FIG. 3 that shows the method for the creation of the behavioral model. At step 120 the behavioral model creation is initiated. At step 122 the set of participating events from the storage is defined by the user of the system. For example, the user could determine that the model will be built such as to be based on the events collected or occurred in last 30 days or in any other period. Optionally, at step 124 sampling is performed in order to reduce the number of events affecting the building of the behavioral model. The probability that an event will be sampled is determined by a pre-defined sampling configuration parameter predetermined by the user of the apparatus of the present invention. At step 126 the defined parameter classifications are calculated using a similarity metric that defines the classification or by providing a function the result of which is defined as the parameter classification, as described in detail in association with the text above. At step 130 the modeling events groups are calculated based on the classifications of the events or associated with the events. At step 134 the modeling event groups are stored in the behavioral model 138. In an alternative but substantially simultaneously process the following steps are performed. At step 128 all the potential patterns are obtained. At step 132 the relevant patterns are found and at step 136 the patterns are stored in the model 138

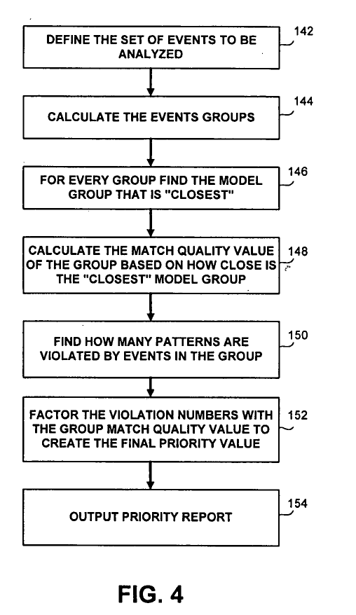

Referring now to FIG. 4 that shows the method of the event analysis. During event analysis a set of events are obtained and a current behavioral model-based analysis is performed on the events. At step 140 one or more events are received to be analyzed. At step 142 a set of events to be analyzed is defined. At step 144 the events groups are calculated. At step 146 for every event group a modeling event group is found in the behavioral model that is the “closest” to the event group. This calculation is further described in detail in association with the text above. At step 148 the match quality value of the event group is determined based on the “distance” of the event group to the modeling event group in the behavioral model, as is further described in detail in the text above. At step 150 the number of patterns in the behavioral model that are violated by or are incompatible with the parameters of the events in the events group are calculated. At step 152 the number of violations or incompatibilities is factored with the match quality value of the event group in order to create a priority value. The priority value is normalized to a number between 0 and 100 or a like normalized range. At step 154 a priority value report is produced. The normalized priority value is used as the “importance” indicator of the analysis events group and the association of the events with the analysis events group provides a human analyzer with the option of selective viewing of grouping of events. Thus, a human analyzer is capable to view reports in analysis group granularity by directly accessing events associated with specific analysis events groups. In addition, a human analyzer is provided with the option of viewing reports in analysis events group granularity where the events are accessed sequentially via the groups arranged by the priority indicator.

Still referring to FIG. 4, the grouping of the events during the event analysis is similar to the grouping of the events group while generating the behavioral model since preferably the same similarity metrics is used by both the behavioral model builder and the event analyzer. The event analyzer processes all the event groups and find the optimal matches among the event groups of the behavioral model. The match quality is defined in one of the following non-limiting ways: the distance measure between the groups, factoring the distances between each pair of events in two groups, and the like. The distance between group A and group B could de defined: 1) by the largest distance between any two events (one in group A and one in group B), or 2) by the smallest distance between any two events (one in group A and one in group B) or 3) by the distance between the center of both groups where the center is an event with the smallest maximal distance to any other event in the group, or 4) any factoring of the above discussed methods, or 5) any other suitable method The outcome is a set of event groups in the behavioral model that are “closest” to the processed event group. The higher the match quality the more similar the processed event group to historical events or events that occurred in the past. The event analysis identifies events that violate any of the patterns in the behavioral model. Each violation receives a score based on the relevant pattern quality. Subsequently a group-specific total violation score is calculated based on the number of violations, quality of violations, number and ratio of violations, and the like. Based on the match quality value and the violations score a priority value is calculated and assigned to the event group. The priority value is calculated such as to represent the distance of the event group from the “ordinary” or “standard” behavior.

The underlying logic of the methods utilized by the real-time event analysis and the off-line event analysis are substantially similar. There are two differences between the two analyzers. In real-time analysis the analysis events groups are defined in real-time dynamically according to the following logic: a) initially no analysis event groups exist, b) for every event that is obtained and handled the analyzer selects the most appropriate group out of the existing groups based on the events similarity metrics. The similarity should exceed a specifically calculate threshold If no existing analysis events group is appropriate then a new group is created. New events that are assigned cumulatively to existing analysis events groups may change the violation score of the entire group. Therefore the anomaly score or the priority indicator of the analysis events group may change in time.

The proposed apparatus and method of the present invention typically implemented and operates on a computing platform. The computing platform is a hardware device, such as a mainframe computer, a minicomputer, a desktop computer, a personal digital assistant, a microcomputer, and the like, having sufficient computing resources in order to run and execute applications. The computing platform typically includes a memory device, a processor device, a data bus device and a storage device. The memory device is the electronic holding place for instructions and data that the computer's processor can reach quickly. The processor device is preferably the logic circuitry that responds to and processes the basic instructions that drive a computer. The data bus device is the data path on the computer's motherboard that interconnects the processor device with attachments to the motherboard in expansion slots such as hard disk drives, CD-ROM drives, graphics adapters, peripherals, and the like. In the preferred embodiment of the present invention computing platform is linked to one or more external databases. The databases could be installed on one or more distinct computing and data storage platforms in an associated local network or could be located remotely on remote computing platforms linked to a wide area network. The communication path between the platform and the remote/external databases is established by the communication device. The storage device is preferably a Direct Access Storage Device (DASD), such as a magnetic disk, a hard disk or a redundant array of independent disks (RAID) with sufficient storage capacity for holding a plurality of software components and associated data structures. The software components and the associated data structures control the operation of the platform, maintain the constituent software entities of the platform and execute various software applications installed on the platform in accordance with the objectives of the users of the platform. In the preferred embodiment of the invention, the storage device holds a set of software components and a set of data structures. Thus, device includes an operating system, a user interface, and an events analysis application, one or more control tables, a model database, and an events database. The events analysis application is a user application responsible for the prioritization of events and the analysis of the events stored in the event database and/or in the distributed/remote/external events databases. The application includes a set of software routines constituting a user application. The events analysis application is a user application that is responsible for analysis of events either in real-time or off-line. The application includes a model builder component, an event analyzer component, a viewer options selector component, and a viewer component. The model builder component is responsible for the generation of an event model database. The database stores data that represents the characteristics of events in the flow of events in the given environment. In the preferred embodiment of the present invention the database is preferably built by the component where the building process is based on the event records stored in the events database or in the distributed/remote/external events databases. In other preferred embodiments of the invention, initially the model database is built on the set of events for a pre-defined period of time. The database could be further updated to reflect changes in the environment based on additional events. In the preferred embodiment of the present invention each event stored in the events databases is processed by the model builder either in real-time or off-line and based upon their relevant characteristics the model database is updated. The event analyzer component is a set of logically and functionally interrelated software routines. The functionality of component is to obtain in real-time or off-line, continuously or periodically one or more of events from the event databases and to analyze the events in real-time or off-line in accordance with the model stored in the model database. The events databases, the control tables, and the model database are conventional data structures having data storage, data access, and data maintenance and data retrieval capabilities.

The computing platform and the constituent elements thereof as were described herein above are exemplary only and were presented in order to provide a coherent and ready understanding of the present invention. Several standard key computing elements were not shown. For example, in a realistic environment, a computing platform could optionally include several diverse user applications, several application-specific databases, control tables, and the like.

It will be appreciated by persons skilled in the art that the present invention is not limited to what has been particularly shown and described hereinabove. Rather the scope of the present invention is defined only by the claims which follow.

I claim:

1. An apparatus having an at least one central processing unit and an at least one storage device, for the grouping and prioritizing of events, the apparatus comprising:
a behavioral model builder component to generate and store a behavioral model, said behavioral model comprises:
at least one modeling event group, the modeling event group comprises an at least one modeling parameter classification associated with a parameter type wherein one or more parameter values are stored; the
modeling events group are associated with one or more events having similar parameter values.

2. The apparatus of claim 1 further comprising a behavioral model storage to store the behavioral model.

3. The apparatus of claim 1 wherein the behavioral model further comprises modeling patterns.

4. The apparatus of claim 1 further comprises: ‘an event storage component to receive at least one event from event collector components, to store the received at least one event and to transfer the received at least one event to one or more of the behavioral model builder and model storage component and to the event analyzer component; and
an events storage to receive at least one event from the event storage component, to hold the at least one event as a stored event entity and to provide the at least one event entity to the event analyzer component.

5. The apparatus of claim 3 wherein the event entity is a data record.

6. The apparatus of claim 3 wherein the event entity stored in the event storage comprises;
an at least one event parameter comprising a parameter type indicator and a parameter value; and
an event identifier to uniquely identify the event.

7. The apparatus of claim 1 wherein the behavioral model further comprises an at least one modeling pattern relating to the modeling events.

8. The apparatus of claim 3 wherein the event entity stored in the event storage comprises an at least one timestamp to indicate a specific point in time associated with the at least one event.

9. The apparatus of claim 1 further comprising an event analyzer component to associate an at least one event with a modeling event group, and to calculate the priority indicator of the at least one event in accordance with the characteristics of the associated modeling events group information stored in the modeling events group in the behavioral model and the quality of matching achieved between the event information stored in the modeling events group in the behavioral model and the characteristics of the event.

10. Within a computerized platform having an at least one central processing unit and at least one storage device, a method for the grouping and prioritization of events, the method comprising:
generating a behavioral model comprising one or more behavioral modeling event groups based on one or more characteristics of one or more modeling events;
grouping one or more events into an modeling event groups based on the characteristics of the events and based on the characteristics of one or more substantially matching modeling event groups in the behavioral model.

11. The method of claim 10 wherein generating of the behavioral model comprises:
calculating the modeling classifications by the modeling event parameter values; and
calculating the modeling events groups.

12. The method of claim 10 wherein generating of the behavioral model further comprises: finding the relevant modeling patterns; and storing the modeling events, modeling patterns and modeling parameters into the behavioral model.

13. The method of claim 10 further comprises: defining a set of events participating in the building of the behavioral model; and reducing the number of events by performing a sampling process.

14. The method of claim 10 wherein grouping the modeling events into the modeling event groups comprises: calculating the modeling events groups; and matching the events groups to the modeling events groups in the behavioral model.

15. The method of claim 10 wherein calculating the priority value comprises: calculating a quality value indicating the match quality of the event group with the modeling event group in the behavioral model to generate an event group priority value.

16. The apparatus of claim 10 wherein an event is an occurrence represented by data elements.

17. The method of claim 11 further comprising the steps of determining a priority value characterizing the event group; and assigning the priority value to the event group.

18. Within a computerized platform having an at least one central processing unit and at least one storage device, a method for the grouping and prioritization of events, the method comprising:
receiving events to be analyzed;
calculating one or more event groups based on parameters values associated with the events;
for each event group associate an at least one modeling event group associated with a behavioral model;
determined match quality value for the event group based on the distance of the event group to the modeling event group in the behavioral model;
determined the number of patterns in the behavioral model that are violated with the parameters of the events in the events group;
factoring the number of violations with the match quality value of the event group; and
generating a priority value.

19. The method of claim 18 further comprises the step of defining a set of events to be analyzed.

20. The method of claim 18 further comprises printing or displaying a priority report or a priority display based on the priority values of the event groups.

21. The method of claim 18 wherein the step of associating a modeling event group is based on the distance between the event group and the modeling event group within a behavioral model.

22. The method of claim 18 further comprising the step of normalizing the priority value.

23. The method of claim 18 wherein the grouping of the events is performed in real time.

24. The method of claim 18 wherein the grouping of the events is performed periodically or triggered manually.

25. The method of claim 18 wherein calculating and assigning priority values to the event groups is performed in real time.

26. The method of claim 18 calculating and performing priority values to the events groups is performed periodically or triggered manually.

27. A computer readable storage medium containing a set of instructions for a general purpose computer, the set of instructions comprising and event analyzer, said event analyzer performing the following steps:
receiving events to be analyzed;
calculating one or more event groups based on parameters values associated with the events;
for each event group associate a modeling event group associated with a behavioral model;
determined match quality value for the event group based on the distance of the event group to the modeling event group in the behavioral model;
determined the number of patterns in the behavioral model that are violated with the parameters of the events in the events group;
factoring the number of violations with the match quality value of the event group; and
generating a priority value.
